(19) United States
(12) Patent Application Publication
(10) Pub. No.: US 2013/0009478 A1
(43) Pub. Date: Jan. 10, 2013

(54) PHOTOVOLTAIC ARRANGEMENT

(76) Inventor: Bernhard BECK, Volkach OT Dimbach (DE)

(21) Appl. No.: 13/544,504

(22) Filed: Jul. 9, 2012

(30) Foreign Application Priority Data
Jul. 7, 2011 (DE) 10 2011 106 877.9

(51) Int. Cl. H02J 3/46

(52) U.S. Cl. 307/53

(57) ABSTRACT

An arrangement with a photovoltaic generator is provided that can be connected to the input of a power inverter, the output of which is connected to a supply network. The arrangement further comprises an asynchronous machine parallel to the output of the power inverter, which asynchronous machine is driven by an internal combustion engine.

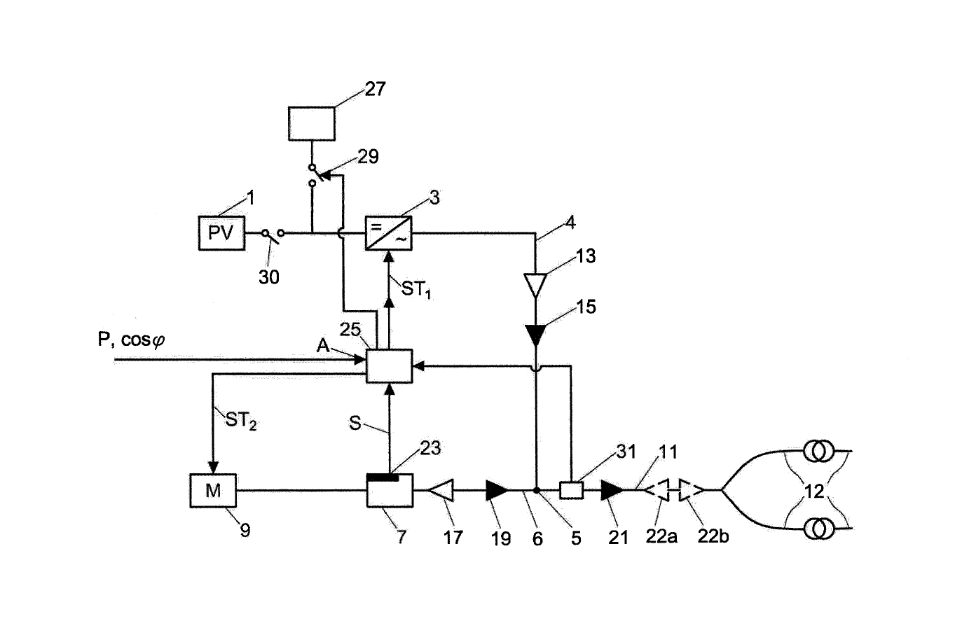

This nonprovisional application claims priority under 35 U.S.C. §119(a) to German Patent Application No. DE 10 2011 106 877.9, which was filed in Germany on Jul. 7, 2011, and which is herein incorporated by reference.

### BACKGROUND OF THE INVENTION

1. Field of the Invention

The invention relates to an arrangement with a photovoltaic generator, which is connectable to a power inverter connected at an output side to a supply network.

2. Description of the Background Art

In the practice of public power supply, narrow limits are generally set by the energy providers for the so-called cos phi value of the power suppliers and the power consumers. For example, the permissible value for a reactive power draw or reactive power feed without penalty in Germany is 0.95. This measure is used to stabilize the networks in order to avoid an overvoltage, which can lead to a destruction of connected consumers, and an undervoltage, which can lead to a failure of consumers. Thus an infeed or a draw of reactive power outside the bandwidth stipulated for the cos phi by the energy supplier or top network operator results in sanctions in the form of penalty payments

As plants for generating electrical energy, for example, photovoltaic generators (PV generators) are known. Each PV generator generates a direct current, which is converted into an alternating current by means of a power inverter. Devices that can generate an alternating current from a direct current are to be considered power inverters. The electronic components of a power inverter permit the adjustment of a desired cos phi value. This takes place in most PV plants by means of a cos phi indicator, via which a fixed ratio of fed power to fed or drawn reactive power can be adjusted. The control unit, for example, is thus instructed to adjust any power fed into the network at a cos phi of 0.97.

To promote the network stability of a supply network it is known from DE 10 2007 018 683 A1, for example, to use a control unit in order to adjust the draw or the output of active power or reactive power from the or into the supply network depending on the mains voltage.

In a photovoltaic plant (PV plant) with a power inverter, this usually has a power rating of predetermined size, which is adapted to the capacity of the PV generator or the PV plant. The full capacity utilization of the power inverter is not always given, since only the capacity that the PV generator is currently able to provide can always be processed.

### SUMMARY OF THE INVENTION

It is therefore an object of the invention to utilize a reactive power supply by means of a power inverter of a PV generator in an energy-efficient manner.

To this end it is provided according to an embodiment of the invention that an asynchronous machine is connected in parallel to the output of the power inverter of a PV generator, which asynchronous machine is driven by an internal combustion engine.

An embodiment of the invention is thereby based on the consideration that, although on the one hand the use of a driven asynchronous machine for power generation and feed into a supply network does not appear expedient per se, especially as—regardless of a high energy efficiency—a network-destabilizing effect occurs hereby. Thus an asynchronous machine operates with a cos phi of approximately 0.8 and thus in a voltage-reducing manner, which is unacceptable for a network operator, since in order to maintain stability, the network operator permits only values of 0.95 for the cos phi in order to keep the voltage stable in the network.

On the other hand, the existing power inverter of the photovoltaic generator can be used to compensate for the poor cos phi of the asynchronous machine via a reactive power supply by means of the power inverter. Under this prerequisite, an asynchronous machine operating as a generator, which, in contrast to a synchronous machine, does not require a complex mains connection and is comparatively economical, can be used in a cost effective manner for current feed.

Now modern power inverters have the property that in addition to or also instead of active power, they can likewise feed reactive power into the supply network or can draw it from the supply network via the adjustment of their operating point. Otherwise, that is, without the connection according to the invention of the power inverter, an investment would have to be made in a complex reactive power compensation plant with coils and/or capacitors, which is not economical.

If this property of the power inverter of a PV plant is used, for example, in regions in which, in particular at night when no solar energy is available, oil is used for power generation, with the combustion of the oil the specific consumption can be reduced. In turn the oil saved, instead of being converted into electric current in areas rich in sun, can be transported to remote regions and converted into electric current there or fed to other comparatively energy-efficient uses.

The advantage is thereby to be seen in particular in that the oil saved, instead of the current that hitherto has not been transportable due to the lack of lines, can be transported into other regions with less sun. The transport of the current generated or that can be generated in areas rich in sun, which hitherto has not been feasible due to the lack of current transfer lines, can thus be replaced by a feasible transport of oil, wherein the overall balance of the energy consumption by oil combustion in combustion engines remains the same.

The advantages of the arrangement with its combination of an asynchronous machine and a photovoltaic power inverter therefore lie in particular in that:

A predetermined power can be provided reliably and continuously,

The photovoltaic plant saves the combustion of oil,

The voltage stability can be ensured even without the operation of a machine, and

No additional compensation device is necessary.

### BRIEF DESCRIPTION OF THE DRAWING

Further advantages and embodiments of the invention are shown by the description of an exemplary embodiment based on a drawing, the only FIGURE of which shows a diagrammatic structure with power flows of the arrangement according to the invention.

### DETAILED DESCRIPTION

A photovoltaic generator 1 is shown diagrammatically, which is connected to an input, not designated in further detail, of a power inverter 3, which converts the direct current generated by the photovoltaic generator 1 into an alternating current. From the power inverter 3 a first supply lead 4 leads to a junction point 5, into which the power is fed in. A second supply lead 6 is connected to the junction point 5, which supply lead is guided to the output of an asynchronous machine 7. The asynchronous machine 7 is driven by a combustion engine 9, such as, e.g., a diesel engine and thus operates as an asynchronous generator. From the junction point 5 a network lead wire 11 leads via disconnectors, not shown, to a supply network 12, into which the current generated by the photovoltaic generator 1 and by the asynchronous machine 9 is fed. The power inverter 3 is thus connected on the one hand on the output side via the junction point 5 to the supply network 12. On the other hand, the asynchronous machine 7 is arranged parallel to the power inverter 3, i.e., to the alternating current outlet thereof, not designated in further detail.

The figure shows on the first supply lead 4 a first hollow triangle 13 and a first solid triangle 15. The hollow triangle 13 symbolizes a reactive current component, which is fed from the power inverter 3 into the junction point 5. In an analogous manner, the first solid triangle 15 symbolizes the active power component. A tip of both triangles 13, 15 is respectively directed to the first supply lead 4. This represents the power flow, which as reactive power as well as active power leads from the photovoltaic generator 1 via the power inverter 3 to the junction point 5.

On the second supply lead 6 a second hollow triangle 17 is drawn, the direction tip of which points to the asynchronous machine 7. This symbolizes that the asynchronous machine 7 draws a reactive power component. The active power generated by the machine unit formed by the combustion engine 9 and the asynchronous machine 7 is likewise fed into the junction point 5, which is symbolized by a second solid triangle 19.

The reactive power component generated by the power inverter 3 is coordinated with the reactive power draw of the asynchronous machine 7 such that the power flow on the network lead wire 11 is preferably pure active power. This is symbolized by a third solid triangle 21 on the network lead wire 11, the tip of which points in the direction of the supply network 12. If the network operator in addition wants a reactive power component, a reactive power draw can be carried out from the supply network or a reactive power feed can be carried out into the supply network by changing the operating point adjustment. This is shown by two hollow triangles 22a and 22b, drawn by dashed lines, for the draw or for the feed.

The asynchronous machine 7 has a signal output 23, to which a signal line is connected, which leads to a logic and control unit 25. A signal S is transmitted via the signal line, which signal is a gauge of the cos phi with which the asynchronous machine currently operates. In the logic and control unit 25 a control signal ST₁ is generated, which triggers the semiconductor switches inherently contained in the inverter 3, in particular in the form of IGBTs such that the component of reactive power supplied on the part of the power inverter 3 is equal to that drawn by the asynchronous machine 7. In this manner the power can be transmitted on the network lead wire at a cos phi of 1. In the case of another instruction with a desired cos phi value not equal to 1, the reactive power component generated by the power inverter 3 deviates accordingly from the value drawn by the asynchronous machine 7.

The logic and control unit 25 is connected via a control line to the combustion engine 9, via which a control signal ST₂ is transmitted, by means of which the power of the engine 9 is adjusted.

It is expedient to be able to provide a quick power supply in order to bridge the length of time that the combustion engine 9 requires with the asynchronous generator 7 after a corresponding instruction on the part of the network operator in order to feed power into the supply network 12. To this end, a battery 27 is connected parallel to the photovoltaic generator 1, which battery can be switched if necessary via a first switching device 29 to the input side of the power inverter 3. The battery 27 feeds electric energy into the power inverter 3 in addition to (or at night, instead of) the photovoltaic generator 1, until the machine unit composed of the asynchronous generator 7 and the combustion engine 9 has started up. Once it has successfully started up, the machine unit 7, 9 provides the supply network 12 instead of the battery 27 with the desired electric power.

The photovoltaic generator 1 can be disconnected from the power inverter 3 by means of a second switching device 30. The opened second switching device 30 is used, for example at night, to avoid a reverse current into the photovoltaic generator 1, when the battery 27 is connected to the input side of the power inverter 3.

To sum up, an arrangement with a photovoltaic generator 1 is thus provided, which can be connected to the input or to the input terminals of a power inverter 3, the output of which is connected to a supply network 12, wherein an asynchronous machine 7 driven by a combustion engine 9 is arranged parallel to the output. The advantage of the arrangement according to the invention lies in particular in that the use of asynchronous machines is rendered possible, although they operate per se at an unfavorable cos phi. Thus the unfavorable cos phi can be compensated by means of the power inverter 3, in particular by means of the electronically regulated IGBTs thereof.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An arrangement comprising:
a photovoltaic generator that is connectable to an input of a power inverter, an output of the power inverter being connectable to a supply network; and
an asynchronous machine configured to be driven by an internal combustion engine, the asynchronous machine being connectable in parallel to the output of the power inverter.

2. The arrangement according to claim 1, wherein a battery is connectable in parallel to the input of the power inverter.

3. The arrangement according to claim 1, wherein a power network infeed takes place on the part of the photovoltaic generator and the asynchronous machine at a preselectable cos phi and/or a predetermined power.

4. The arrangement according to claim 3, wherein in sum a power infeed on the part of the photovoltaic generator and the asynchronous machine takes place at a cos phi in the amount of 0.99 to 1.

5. The arrangement according to claim 1, wherein, with the asynchronous machine switched off, the power inverter is connectable to the supply network at a predetermined cos phi and draws reactive power therefrom or feeds reactive power into it.

6. The arrangement according to claim 3, wherein a logic and control unit which based on an instruction signal controls a power of the combustion engine and adjusts the cos phi of the power inverter.

7. The arrangement according to claim 6, wherein actual values of a fed current and of the prevailing mains voltage are supplied from a measuring point in the supply network to the logic and control unit in order to regulate it via desired values contained in the instruction signal.
